(19) United States
(12) Patent Application Publication
(10) Pub. No.: US 2009/0094700 A1
(43) Pub. Date: Apr. 9, 2009

(54) INFORMATION PROCESSING APPARATUS

(75) Inventors: Takeshi GOTO, Fukuoka (JP); Hiroaki HARUYAMA, Fukuoka (JP); Nobuyuki GOTO, Fukuoka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/246,702

(22) Filed: Oct. 7, 2008

(30) Foreign Application Priority Data
Oct. 9, 2007 (JP) 2007-263114

(51) Int. Cl. G06F 21/00

(52) U.S. Cl. 726/26

(57) ABSTRACT

An information processing apparatus includes a housing that accommodates electronic components for processing security information, a power source that supplies power to the electronic components, a detection circuit that is connected in parallel to the power source with respect to the electronic components and detects an abnormality when a physical opening action affects the housing, a memory processing section that deletes the security information or makes it impossible to read out the security information from a memory in the electronic components when the abnormality is detected, and a notifying section that notifies the abnormality when the abnormality is detected. When the abnormality is detected, power is supplied from the power source to the memory.

### BACKGROUND

The present invention relates to an information processing apparatus that makes it difficult to unlawfully take out information and notifies of any unlawful action by immediately detecting it if any.

In recent years, an information processing apparatus for which high security is required, such as a card reader, a tag reader, an electronic transaction apparatus, etc., is indispensable from a societal perspective. In such an information processing apparatus, it is necessary to take a countermeasure at least in terms of software so that confidential information does not leak. And, further countermeasures are needed so that information stored in hardware memory itself does not leak by stealing of the hardware.

As a prior art technology, there is, for example, an information processing apparatus disclosed in JP-A4-128948. In the information processing apparatus, if the hardware itself is stolen and the cover is opened, power supplied to the backup memory is interrupted, wherein data in the memory is destroyed. A confidentiality retention circuit of wired logic is used, in which transistors and a micro switch are adopted.

However, in the information processing apparatus disclosed in JP-A4-128948, the memory data are configured so as to be immediately destroyed by flipping on a micro switch if the main body housing is opened. Therefore, there is a problem in that, without opening the main body housing, for example, where a hole is drilled in the main body housing by a drill etc., and an eavesdropping operation is carried out, security of the information processing apparatus becomes insufficient.

Also, since the data are immediately deleted when the main body housing is opened, it was necessary to reset the data even when the main body housing is opened for the purpose of maintenance etc., of portions not pertaining to security, wherein the operation was cumbersome.

Therefore, it has been proposed that an electronic transaction apparatus from which electronic transaction information is difficult to be stolen and for which maintenance of a portion not pertaining to security can be easily carried out is provided (refer to JP-A-11-353237).

FIG. 10 is a schematic view showing a prior art security housing. The security housing 101 includes ten keys exposed outside an electronic transaction apparatus main body, a CPU 102 for carrying out information processing, a program memory 103 having communication programs etc., with a host computer stored therein, a key memory 104, in which encipherment keys are registered in advance, for temporarily storing encipherment keys sent from the host computer, an information memory 105 for temporarily storing a password input from the ten keys and other electronic transaction information and storing electronic transaction information from the host computer, a memory power source 106 for supplying power to the key memory 104 and information memory 105, a security switch 107 for interrupting power supplying from the memory power source 106 to the key memory 104 and the information memory 105, and a printed pattern wiring film (FPC) 108 for supplying power from the memory power source 106 to the key memory 104 and the information memory 105. The printed pattern wiring film (FPC) 108 is a single long and redundant meandering wiring circuit.

In the electronic transaction apparatus disclosed in JP-A-11-353237, electronic components are housed in the security housing in the main body housing, and wires of the above printed pattern wiring film 108 are widely spread across the inside of the security housing, wherein the functions of the apparatus are stopped by disconnection of the wires. Therefore, maintenance of electronic components etc., for which security is not required can be easily carried out. Also, information regarding electronic transaction in the security housing cannot be stolen, wherein safety is improved.

In addition, as a security retention apparatus of almost the same technology as disclosed in JP-A-11-353237, an integrated circuit covered by a flexible circuit consisting of a meandering wiring circuit has also been proposed (refer to U.S. Pat. No. 5,761,054). However, the flexible circuit disclosed in U.S. Pat. No. 5,761,054 does not correspond to a security housing.

As described above, the information processing apparatus disclosed in JP-A-4-128948 is configured so that data of the memory are destroyed by flipping on a micro switch if the main body housing is opened. However, if a hole is drilled in the main body housing by a drill etc., an eavesdropping operation can be carried out, wherein there is a fear that the security may be broken. Also, since the data are destroyed at this time, maintenance work etc., thereof becomes cumbersome.

Accordingly, as disclosed in JP-A-11-353237, if FPC wires are widely spread across the inside of the security housing, and the memory function is stopped by disconnection of the wires, the security is reliably improved.

However, the apparatus only prevents information from leaking, wherein the administrator is not aware of a situation where a malicious third person unlawfully works the security housing by short-circuiting the FPC etc. Further, the administrator is not aware of short-circuiting that occurs due to accumulation of dust etc., in the security housing. It is important that, for an information processing apparatus, irregularities are detected during real time. Also, it is desired that a fail-safe structure is provided so that data are not unnecessarily deleted when an abnormality such as disconnection temporarily occurs.

Further, it is necessary that, with respect to the pitch of bending conductors of the FPC, the conductors are wired at a narrow pitch so that, when a person who commits an unlawful act accidentally pierces between the conductors, it does not remain undetected. However, if the gap is too narrow, contrarily, the conductors may be short-circuited due to dust etc. These are contrary to each other. Therefore, an information processing apparatus is desired, which is capable of detecting not only unlawful acts but also abnormalities and notifying such to the user.

### SUMMARY

Accordingly, the present invention is developed in view of such situations, and it is therefore an object of the present invention to provide an information processing apparatus that makes it difficult to unlawfully take out information, can notify of any unlawful action in real time by immediately detecting it if any, and can obtain a high security level.

An information processing apparatus according to the present invention, which solves such problems, includes a housing which accommodates electronic components for carrying out information processing of security information and a detection circuit for detecting a physical opening action when the housing receives the physical opening action. The detection circuit is configured by a printed pattern wiring formed directly on an inner surface of the housing. The information processing apparatus further includes a detecting controlling section for detecting an abnormality in the printed pattern wiring by outputting a predetermined detection signal to the printed pattern wiring and detecting a detection output signal, an abnormality determining section for determining that, when the detection signal is coincident with the detection output signal, the housing is normal, and that, when the detection signal is not coincident with the detection output signal, the housing is abnormal, a memory processing section for deleting the security information or making it impossible to read out the security information from a memory to carry out information processing when an abnormality is determined by the abnormality determining section, that there is an abnormality, and a notifying section for notifying an abnormality, when an abnormality is determined by the abnormality determining section, that there is an abnormality.

According to the information processing apparatus of the present invention, the information processing apparatus makes it difficult to unlawfully take out information, can notify of any unlawful action in real time by immediately detecting it if any, and can obtain a high security level.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is an entire configuration view when a printed pattern wiring of the information processing apparatus according to Embodiment 1 of the present invention is singular;

FIG. 2 is a schematic view of signals showing a normal state and an abnormal state when a detection signal is given to the security housing of the information processing apparatus according to Embodiment 1 of the present invention;

FIG. 3 is a schematic view when there is two printed pattern wirings of the information processing apparatus according to Embodiment 1 of the present invention;

FIG. 4 is a schematic view of a signal in a normal state when there is two printed pattern wirings of the information processing apparatus according to Embodiment 1 of the present invention;

FIG. 5 is a schematic view of a signal in an abnormal state when there is two printed pattern wirings of the information processing apparatus according to Embodiment 1 of the present invention;

FIG. 6 is a schematic view of a signal in an abnormal state when two wires of the printed pattern wiring of the information processing apparatus according to Embodiment 1 of the present invention are short-circuited;

FIG. 7A is a schematic view showing a security housing having a first fitting portion of an information processing apparatus according to Embodiment 1 of the present invention. FIG. 7B is a schematic view showing a security housing having a second fitting portion of an information processing apparatus according to Embodiment 1 of the present invention;

FIG. 8 is an enlarged schematic view showing the fitting portion of the security housing of an information processing apparatus according to Embodiment 1 of the present invention;

FIG. 9 is a schematic view showing a circuit of bent conductors using a pressure-sensing conductive connector of the security housing of an information processing apparatus according to Embodiment 1 of the present invention; and

FIG. 10 is a schematic view showing a prior art security housing.

### DETAILED DESCRIPTION OF EXEMPLARY EMBODIMENTS

### Embodiment 1

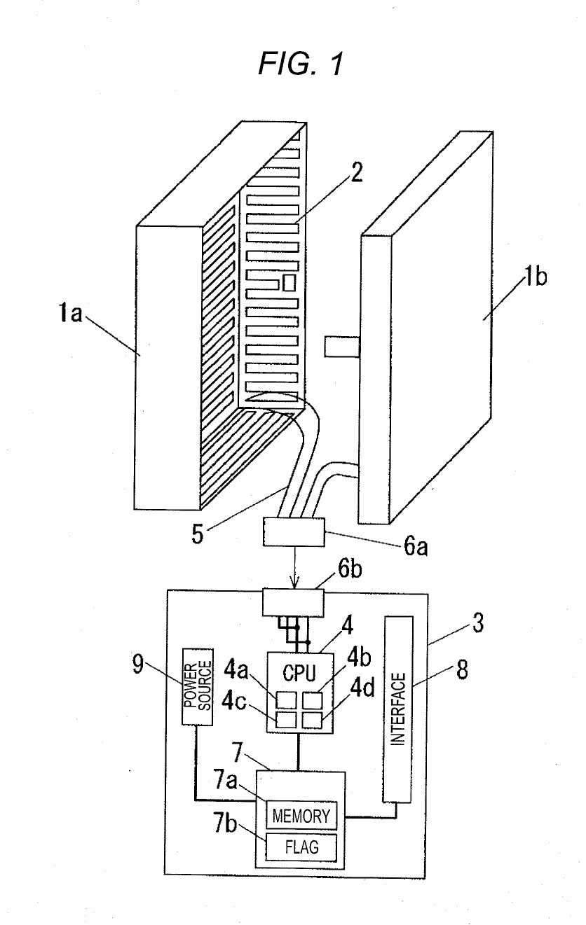

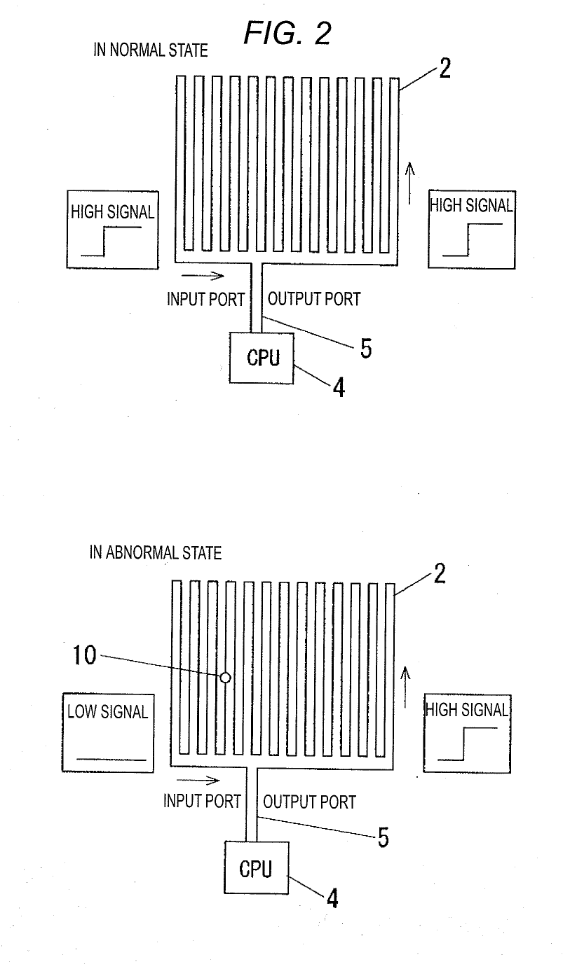

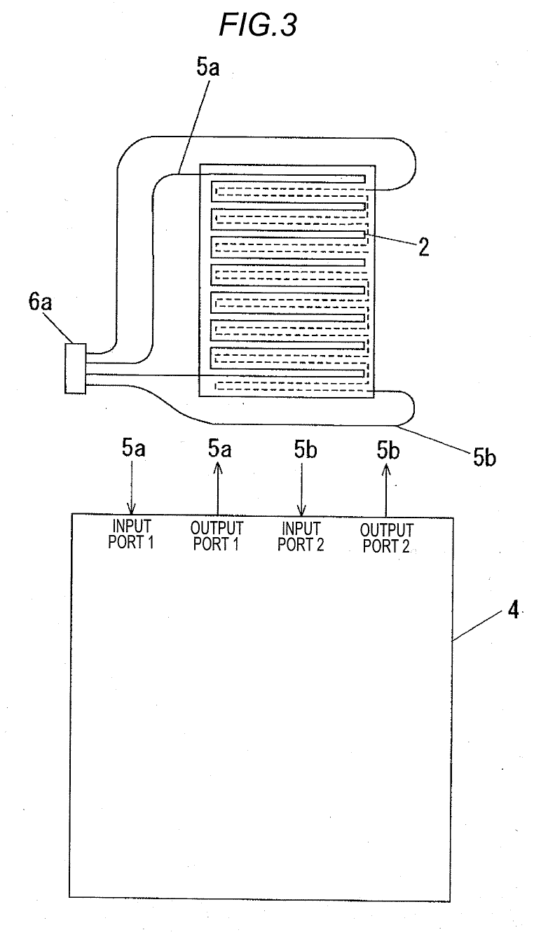

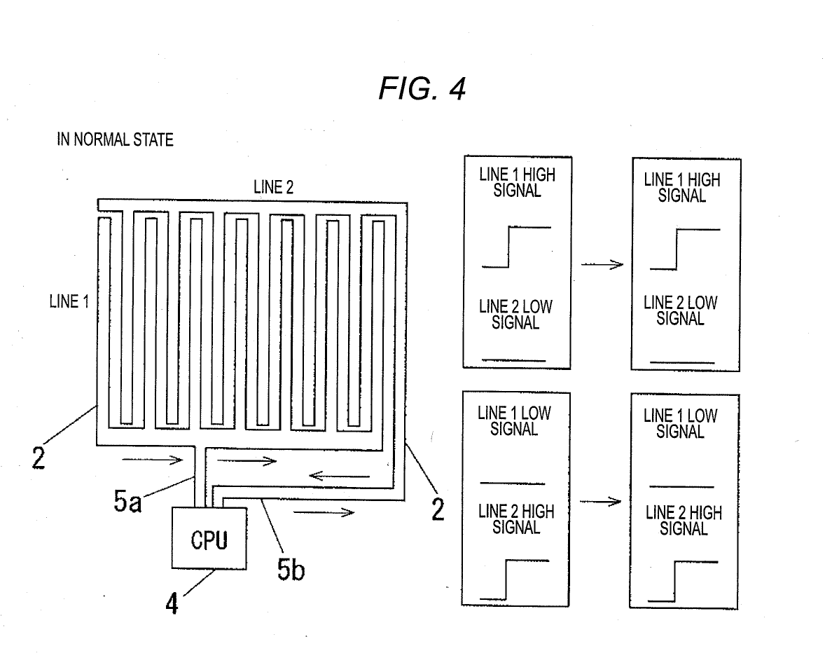

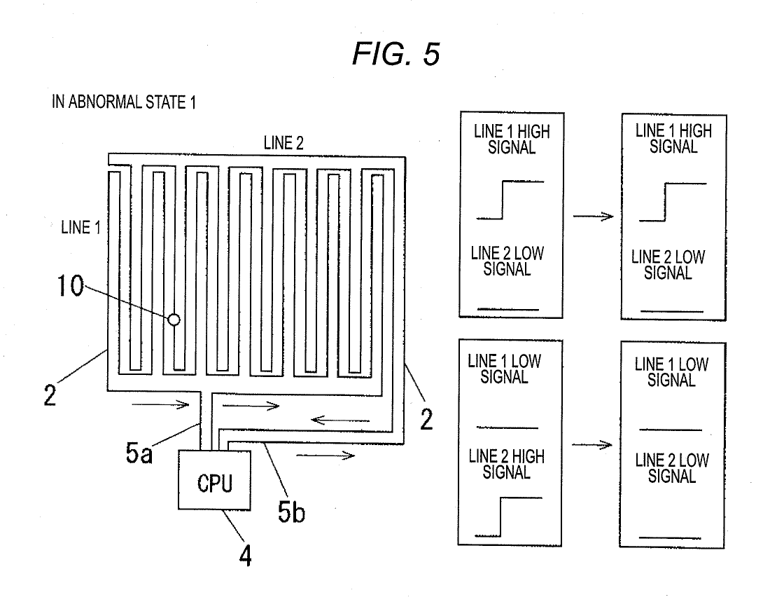

A description is given of an information processing apparatus having a security housing according to Embodiment 1 of the present invention. FIG. 1 is an entire configuration view when a printed pattern wiring of the information processing apparatus according to Embodiment 1 of the present invention is singular, FIG. 2 is a schematic view of signals showing a normal state and an abnormal state when a detection signal is given to the security housing of the information processing apparatus according to Embodiment 1 of the present invention, FIG. 3 is a schematic view when there is two printed pattern wirings of the information processing apparatus according to Embodiment 1 of the present invention, FIG. 4 is a schematic view of a signal in a normal state when there is two printed pattern wirings of the information processing apparatus according to Embodiment 1 of the present invention, and FIG. 5 is a schematic view of a signal in an abnormal state when there is two printed pattern wirings of the information processing apparatus according to Embodiment 1 of the present invention.

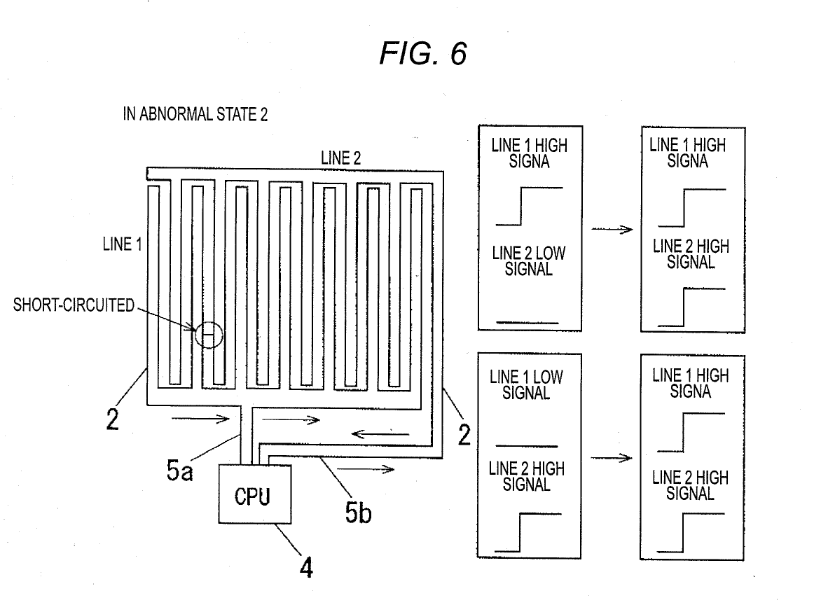

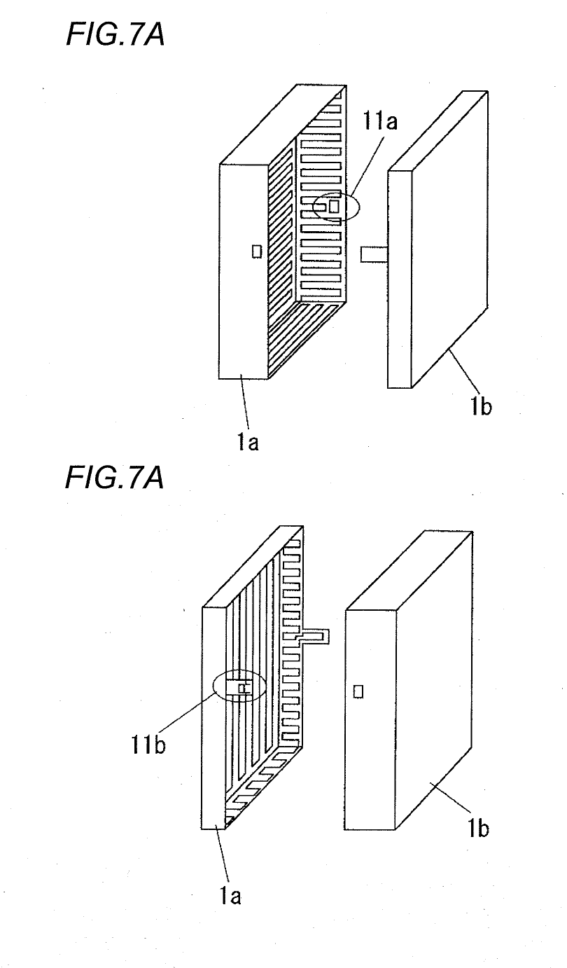

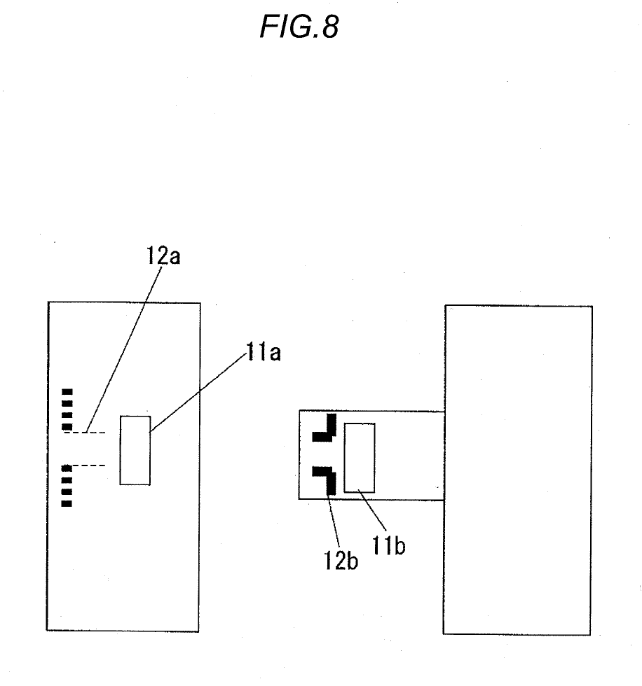

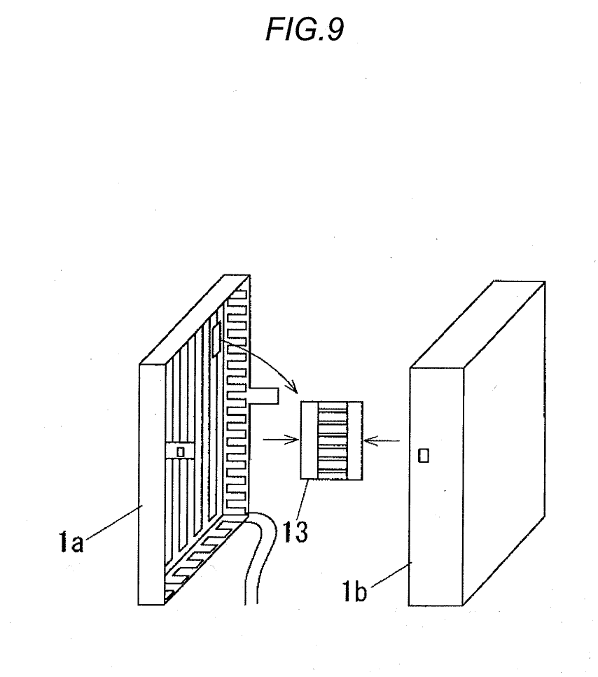

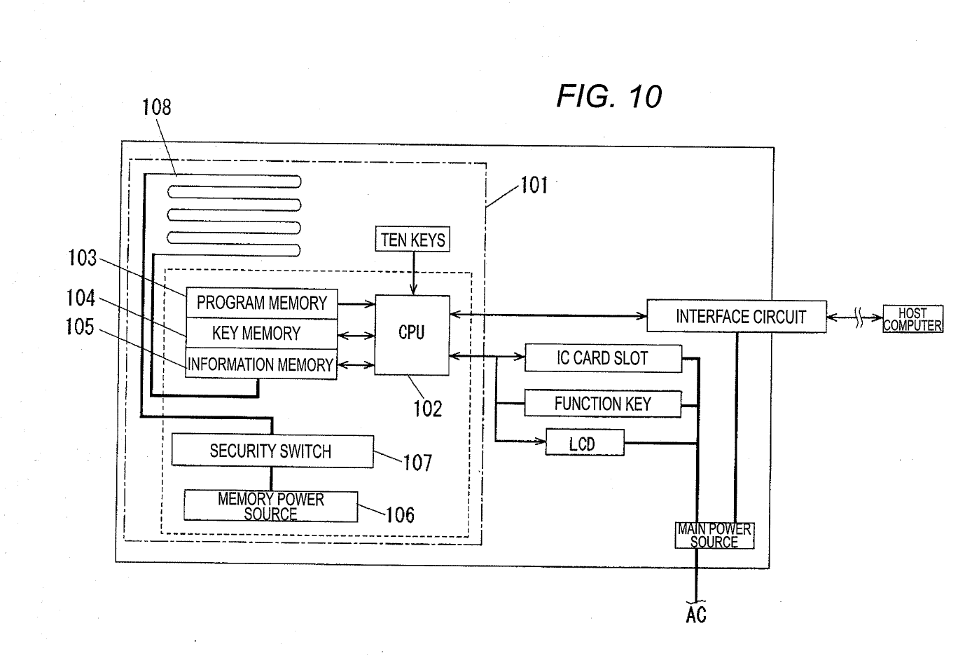

FIG. 6 is a schematic view of a signal in an abnormal state when two wires of the printed pattern wiring of the information processing apparatus according to Embodiment 1 of the present invention are short-circuited, FIG. 7A is a schematic view showing a security housing having a first fitting portion of an information processing apparatus according to Embodiment 1 of the present invention, FIG. 7B is a schematic view showing a security housing having a second fitting portion of an information processing apparatus according to Embodiment 1 of the present invention, FIG. 8 is an enlarged schematic view showing the fitting portion of the security housing of an information processing apparatus according to Embodiment 1 of the present invention, FIG. 9 is a schematic view showing a circuit of bent conductors using a pressure-sensing conductive connector of the security housing of an information processing apparatus according to Embodiment 1 of the present invention, and FIG. 10 is a schematic view showing a prior art security housing.

Here, an information processing apparatus according to Embodiment 1 is an apparatus for which a high security level is requested, such as a card reader, a tag reader, an electronic transaction apparatus, etc. In such an information processing apparatus, a reading portion to read the information when inserting an IC card etc., or passing a tag etc., and a writing portion are provided as a requisite apparatus. However, as for the security housing and information processing apparatus according to the present invention, since detailed configurations thereof are not critical, these are not illustrated.

However, brief descriptions are given thereof. Roughly the following two systems are available as the communication system for reading and writing. The first type is a communications system based on electromagnetic induction. Also, there are two types (a) and (b) in the system based on electromagnetic induction, wherein (a) is a type in which the use frequency is 400 kHz through 530 kHz, the electromagnetic coupling degree is high, and communications are carried out by mutual induction/electromagnetic induction between the coil of an IC card, etc., and the coil of an information processing apparatus, and (b) is a type in which electromagnetic waves mainly of 250 kHz or less or 13.56 MHz are utilized, the electromagnetic coupling degree is comparatively low, and communications are available by using an induced voltage between both the coils.

On the contrary, the second type is based on electric waves, in which electric waves radiated from an antenna of an information processing apparatus are received by an IC card, a tag, etc., and data are transmitted by using the reflected waves. Therefore, originally, the information processing apparatus according to Embodiment 1 includes coils and an antenna, and is provided with a reading portion and a writing portion that read out and write by overlapping digital information on communication waves (electromagnetic induction, electromagnetic waves, and electric waves).

Here, in FIG. 1, reference numeral 1 denotes a security housing (housing) of an information processing apparatus, 1a denotes a housing case (the first case of the present invention) of the security housing 1, and 1b denotes a housing cover (the second case) of the security housing 1. Printed pattern wiring that detects an unlawful opening, disassembling and breakage action of the security housing 1 (physical opening action) is formed on the respective interior surfaces of the housing case 1a and housing cover 1b. Reference numeral 2 shown in FIG. 1 is a labyrinth-like wired circuit in which a single bent (meandering) conductor is incorporated at a predetermined pitch (width) on the insulative housing or is printed pattern wiring (detection circuit) formed as a printed pattern wiring film.

The printed pattern wiring 2 is such that metallic powder including copper, etc., and other conductive powder is transferred, as a bent detection circuit, by a thermal transfer printer, etc., directly on the security housing or as a printed pattern wiring film. In addition thereto, a circuit of bent conductors may be left by forming a resist pattern and etching exposed copper foil portions by a chemical agent, or on the contrary, the circuit may also be formed by forming a resist pattern and plating only the circuit portions of bent conductors with copper.

Reference numeral 3 shown in FIG. 1 denotes a substrate (an electronic component for processing security information) accommodated in the security housing 1. The substrate 3 is provided with at least the following elements. Reference numeral 4 denotes a CPU to carry out control by calculation processing in compliance with programs, and 4a denotes a detection controlling section operating as function implementing unit.

The function implementing unit executes the procedure in compliance with programs that the CPU 4 has read in its main memory and implements predetermined functions.

Also, a starting end and a trailing end of the printed pattern wiring 2 directly formed on or adhered to the housing case 1a are respectively connected to the connector 6a by lead wires 5, and the starting end and the trailing end of the printed pattern wiring 2 directly formed on or adhered on the housing cover 1b are connected to the connector 6a by separate lead wires 5, respectively.

The connector 6a is mounted to the connector 6b provided on the substrate 3 and is electrically connected thereto. A detection signal is output from the CPU 4 to the respective printed pattern wiring 2 of the housing case 1a and the housing cover 1b, respectively. After the detection signal is transmitted and distributed to the wiring circuit, the detection signal can be detected at the starting end side as a detection output signal.

Here, reference numeral 7 denotes a memory configured by a ROM in which programs along which the CPU 4 operates are stored, a RAM that temporarily stores, and a non-volatile ROM, etc. Reference numeral 7a denotes a circuit status flag that is set by whether the detection controlling section 4a inputs a HIGH signal or a LOW signal in the printed pattern wiring 2.

Provisionally, when a HIGH signal is output from the CPU 4, the circuit status flag 7a provided in the memory 7 is set to HIGH. However, if the detection signal (the detection output signal) detected at the trailing end side at this time is LOW, the abnormality determining section 46 determines that some abnormality has occurred because the detection output signal is a LOW signal although the circuit status flag 7a is HIGH in its original state. Further, when a HIGH signal is transmitted and a HIGH signal is detected, the abnormality determining section 4b determines to be normal. And, the detection controlling section 4a sets an abnormal or normal flag at the security flag 7b in the memory 7.

Where it is determined by the above abnormality determining section 4b that there is an abnormality, and an abnormal flag is set in the security flag 7b, a program and data stored in the memory 7 for which security is required are initialized by the memory processing section 4c, and the notifying section 4d notifies an administrator of the point via the interface 8 and network or the interface 8, modem (not illustrated) and a telephone line.

In addition, as a deleting section, the memory processing section 4c may make it impossible to read out the programs stored in the memory 7. That is, a management file to read out the programs and data may be made invalid (removes a pass to read out), and may make an access from a PC etc., impossible with respect to the program and data. Also, in FIG. 1, reference numeral 9 denotes a power source to supply electricity to the entirety of the substrate 3.

Also, as other deleting section, when abnormality is detected, recorded security information may be overwritten by meaningless data, and further may be rewritten by erroneous security information. Accordingly, even if the security information is stolen, only meaningless data are stolen, wherein it is possible to prevent information from leaking.

That is, since power is fed to the substrate 3 by the power source 9 even when an abnormality is detected in FIG. 1, the program and data for which security is required cannot be deleted only by detecting an abnormality even if they are stored in a RAM temporarily, and it is necessary to delete or make it impossible to read out the program and data as described above.

In addition, since power is continuously fed to the CPU 4 and the memory 7 in the substrate 3 by the power source 9 even when an abnormality is detected in FIG. 1, the abnormality can be notified to an administrator via a network in an abnormal state.

Since data can be retained even if power is cut off where a non-volatile ROM is used, security information is maintained in the information processing apparatus as long as an abnormality is not detected, and the security information may be effectively utilized.

Continuously, based on FIG. 2, a description is given of how an unlawful take-out of information is actually detected when it is intended that information is unlawfully taken out by drilling a hole in the main body housing by a drill etc. In a state free from such an abnormality, that is, in a normal state, the detection controlling section 4a of the CPU 4 periodically outputs a pulse-like HIGH signal to the printed pattern wiring 2, or may output a HIGH signal to the printed pattern wiring 2 at all times (that is, voltage is applied at all times).

At this time, the detection controlling section 4a sets the circuit status flag 7a to HIGH before outputting a detection signal, and where the detection output signal is HIGH as well, the abnormality determining section 4b determines to be normal with reference to the circuit status flag 7a since the relationship between both is HIGH→HIGH. In this case, the security flag 7b in the memory 7 is set to be normal.

On the contrary, if the detection controlling section 4a sets the circuit status flag 7a to HIGH, and outputs a HIGH signal to the printed pattern wiring 2 when a hole 10 is drilled halfway through the printed pattern wiring 2 and a conductor of the printed pattern wiring 2 is disconnected, the detection output signal becomes a LOW signal, wherein the relationship between the circuit status flag 7a and the detection output signal is HIGH→LOW and they are not coincident with each other, and the abnormality determining section 4b determines, based thereon, that an abnormality has occurred. The security flag 7b is set to be abnormal.

Here, in the printed pattern wiring 2 described above, the printed pattern wiring 2 is a wiring circuit consisting of a single long and bent conductor in either one of the housing case 1a and the housing cover 1b. Therefore, where if one who knows the internal structure and intends to unlawfully take out information short-circuits the starting end and the trailing end of the printed pattern wiring 2, that is, the lead wire 5, it cannot be recognized that the conductor is disconnected by drilling a hole in the main body housing.

Accordingly, Embodiment 1 shown in FIG. 3 is such that in both the housing case 1a and the housing cover 1b, the printed pattern wiring 2 is made into a labyrinth-like wiring circuit in which a set of independent two long and bent conductors are incorporated. That is, the entire wiring circuit is composed to be four independent wiring circuits consisting of two wires×two sets. The starting end of one (the first conductor circuit) of the set of printed pattern wiring 2 is connected to the lead wire 5a, and the trailing end thereof is connected to the lead wire 5b.

Similarly, the starting end of the other (the second conductor circuit) of set of printed pattern wiring 2 is connected to another lead wire 5a, and the trailing end thereof is connected to another lead wire 5b. Either of them is connected to the connector 6a. The entire circuit of the information processing apparatus is similar to that shown in FIG. 1. Therefore, the ports of the CPU 4, which output detection signals to check abnormality or normality in the respective wiring circuits and detect detection output signals are four ports, which are output ports 1 and 2 (for outputting detection signals) and input ports 1 and 2 (for outputting detection output signals).

Next, based on FIG. 4, a description is given of operations in a normal state. The detection controlling section 4a of the CPU 4 according to Embodiment 1 periodically outputs a pulse-like HIGH signal to the printed pattern wiring 2 through the output ports 1 and 2. First, the detection controlling section 4a outputs a HIGH signal from the output port 1 to line 1 and outputs a LOW signal from the output port 2 to line 2, and detects the detection output signals at the input ports 1 and 2. Thereafter, the detection controlling section 4a outputs a LOW signal from the output port 1 to line 1 and outputs a HIGH signal from the output port 2 to line 2, and detects the detection output signals at the input ports 1 and 2.

That is, when outputting the first pulse signal, the detection controlling section 4a sets the circuit status flag 7a of lines 1 and 2 to HIGH and LOW, and outputs HIGH and LOW signals to lines 1 and 2, respectively, as shown at the upper right part of FIG. 4. On the contrary, where the detection output signal of line 1 is HIGH and the detection output signal of line 2 is LOW, the signals become HIGH→HIGH in line 1 with reference to the circuit status flag 7a, and become LOW→LOW in line 2. Therefore, the abnormality determining section 4b determines to be normal.

When outputting the next pulse signal, the detection controlling section 4a contrarily sets the circuit status flag 7a of lines 1 and 2 to LOW and HIGH, and as shown at the lower right part of FIG. 4, the detection controlling section 4a outputs LOW and HIGH signals to lines 1 and 2, respectively.

On the contrary, where the detection output signal of line 1 is LOW and the detection signal of line 2 is HIGH, the signals become LOW→LOW in line 1 with reference to the circuit status flag 7a, and become HIGH→HIGH in line 2. Therefore, the abnormality determining section 4b determines that these are also normal. Therefore, the CPU 4 sets the security flag 7b of the information processing apparatus to normal. Combinations of HIGH→HIGH and LOW→LOW in lines 1 and 2 are the first combinations of the detection output signal in Embodiment 1 of the present invention.

The above description handles a case where the information processing apparatus is normal. However, based on FIG. 5, a description is given of detection in a case where an abnormality occurs. Although the detection operation is carried out with the same procedure as in the normal case, a description is given of a case where line 2 is disconnected (that is, where there is an abnormality).

As in FIG. 4, first, a HIGH signal is output from the output port 1 to line 1 and a LOW signal is output from the output port 2 to line 2, and the detection output signals are detected by the input ports 1 and 2. After that, a LOW signal is output from the output port 1 to line 1, and a HIGH signal is output from the output port 2 to line 2. Then, the detection output signals are detected by the input ports 1 and 2.

When outputting the first pulse signal, the detection controlling section 4a sets the circuit status flag 7a of lines 1 and 2 to HIGH and LOW, and as shown at the upper right part of FIG. 5, a HIGH signal and a LOW signal are output to lines 1 and 2, respectively.

On the contrary, the detection signal of line 1 becomes HIGH and the detection signal of line 2 becomes LOW. Although line 2 is disconnected by a hole 10, the disconnection cannot be determined because the detection signal is a LOW signal therein with reference to the circuit status flag 7a. Since the signals are HIGH→HIGH in line 1 and are LOW→LOW in line 2, the same determination is brought about up to this point.

However, when outputting the next pulse signal, the detection controlling section 4a sets the circuit status flag 7a of lines 1 and 2 to LOW and HIGH, respectively, and outputs a LOW signal and a HIGH signal to lines 1 and 2, respectively, as shown at the right lower part of FIG. 5.

Therefore, since the line 2 is disconnected, the detection signal of line 1 becomes a LOW signal, and the detection signal of line 2 becomes a LOW signal although it must be a HIGH signal, wherein with reference to the circuit status flag 7a, although the signals are HIGH→HIGH in line 1, the signals are HIGH→LOW in line 2. Therefore, the abnormality determining section 4b determines an abnormality, Therefore, the CPU 4 sets the security flag 7b of the information processing apparatus to abnormal. The combinations of HIGH→HIGH and HIGH→LOW in lines 1 and 2 are the second combination of the detection output signals in Embodiment 1 of the present invention. A line in which the signals become HIGH→LOW is disconnected.

Thus, in the security housing 1 according to Embodiment 1 shown in FIG. 3 through FIG. 5, even when the starting end and the trailing end of one printed pattern wiring 2 is short-circuited with the intention of unlawfully taking out information, it can be detected by the remaining printed pattern wiring 2 that a hole 10 etc., is drilled and the main body housing is broken. And, if one printed pattern wiring 2 is broken, another printed pattern wiring 2 can take a countermeasure, wherein a fail-safe structure can be brought about.

Continuously, when two wiring circuits of long and bent conductors of the security housing 1 shown in FIG. 3 through FIG. 5 are subjected to any erroneous operation by short-circuiting due to dust etc., a description is given of that the detection controlling section 4a and the abnormality determining section 4b can determine the abnormality.

As shown in FIG. 6, in this case, lines 1 and 2 are short-circuited halfway through the wiring circuit of the printed pattern wiring 2. In this state, first, after a HIGH signal is output from the output port 1 to line 1, and a LOW signal is output from the output port 2 to line 2, the signals are detected by the input ports 1 and 2. After that, after a LOW signal is output from the output port 1 to line 1, and a HIGH signal is output from the output port 2 to line 2, the signals are detected by the input ports 1 and 2.

When outputting the first pulse signal, the detection controlling section 4a sets the circuit status flag 7a of lines 1 and 2 to HIGH and LOW, respectively, and a HIGH signal and a LOW signal are output to lines 1 and 2, respectively, as shown at the upper right part of FIG. 6. On the contrary, the detection signal of line 1 becomes a HIGH signal and the detection signal of line 2 also becomes a HIGH signal. The output signal of line 2 is a HIGH signal, and with reference to the circuit status flag 7a, the signal becomes HIGH→HIGH in line 1, and becomes LOW→HIGH in line 2. Essentially, since the signals are HIGH→HIGH in line 1 and are LOW→LOW in line 2, the abnormality determining section 4 can determine the abnormality at this point.

Further, for verification, when the next pulse signal is output, the detection controlling section 4a sets the circuit status flag 7a of lines 1 and 2 to LOW and HIGH, respectively, and as shown at the lower right part of FIG. 5, a LOW signal and a HIGH signal are output to lines 1 and 2, respectively. Therefore, since lines 1 and 2 are short-circuited, the detection output signal of line 1 becomes a LOW signal and becomes a HIGH signal in line 2.

However, with reference to the circuit status flag 7a, the signals become LOW→HIGH in line 1 although the signals must be LOW→LOW in line 1, and the signals are HIGH→HIGH in line 2. Accordingly, the abnormality determining section 4b determines abnormality along with the first abnormality determination. Therefore, the CPU 4 sets the security flag 7b to abnormal. The combinations of LOW→HIGH and HIGH→HIGH in lines 1 and 2 are combinations of the detection output signals for detecting short-circuiting in Embodiment 1 of the present invention.

Thus, in Embodiment 1, in any case where an abnormality flag is set in the security flag 7b where a hole is drilled to unlawfully take out information or where the printed pattern wiring 2 is short-circuited due to dust etc., the memory processing section 4c initializes important programs and data stored in the memory 7, and the notifying section 4d notifies an administrator of the point via the interface 8 and a network or via the interface 8, a modem (not illustrated) and a telephone line. Therefore, it is possible to reliably detect irregularities.

As a deleting section instead of initialization, it may become impossible to read out the programs stored in the memory 7. That is, the management file to read out the programs and data are made invalid, whereby no access is to be permitted to these programs and data.

Next, a description is given of that, when the housing case 1a, the housing cover 1b of the security housing 1 according to Embodiment 1 are disassembled by anyone, it can be detected by using the printed pattern wiring 2. FIG. 7A shows one example of the fitting portion of a security housing of an information processing apparatus according to Embodiment 1, and FIG. 7B shows another example of the fitting portion of the security housing.

In the security case 1 in FIG. 7A, an engagement groove 11a of the housing case 1a is formed near halfway of the conductor of the printed pattern wire 2. And, a part of the printed pattern wiring 2 is cut off near the fitting claw 11b. The fitting claw (not illustrated, refer to FIG. 8) of the housing cover 1b is fitted in the engagement groove 11a, and the conductor provided in the vicinity of the claw is connected to the cutoff wiring circuit, wherein a wiring circuit of a single bent conductor based on the printed pattern wiring 2 is completed.

Therefore, when the housing case 1a and the housing cover 1b of the security housing 1 are disassembled, the wiring circuit of bent conductors is disconnected at this portion, and the detection controlling section 4a carries out a detecting operation, a flag showing an abnormality is set at the security flag 7b by abnormality determination by means of the abnormality determining section 4b, important programs and data stored in the memory 7 are immediately deleted or made impossible to be read out, and the point is notified to an administrator via the interface 8 and a network, or via the interface 8, a modem (not illustrated) and a telephone line.

Similarly, in the security case 1 in FIG. 7B, the fitting claw 11b of the housing case 1a is formed near halfway of the conductor of the printed pattern wiring 2. A part of the printed pattern wiring 2 is cut off in the vicinity of the fitting claw 11b. An engagement groove (not illustrated, refer to FIG. 8) of the housing cover 1b is fitted to the fitting claw 11b, and a conductor provided in the vicinity of the groove is connected, wherein a wiring circuit of a single bent conductor based on the printed pattern wiring 2 is completed. The operations thereof are similar to those of FIG. 7A. FIG. 8 shows the engagement groove 11a and the fitting claw 11b of the security housing 1, wherein reference numeral 12a denotes a conductor provided near the engagement groove 11a, 12b denotes a conductor secured near the fitting claw 11b.

In addition, in Embodiment 1, when the housing case 1a and the housing cover 1b are disassembled, the disassembly can be detected by using the printed pattern wiring 2. This is not restricted to a case where the engagement groove 11a and the fitting claw 11b are used. FIG. 9 shows a case where a pressure-sensing conductive connector detects disassembly of the housing case 1a and the housing cover 1b. In FIG. 9, reference numeral 13 denotes a pressure-sensing conductive rubber connector (pressure-sensing conductive connector) that at least part of a number of conductors placed between both sides are brought into continuity when pressure is given to both sides thereof.

When a compression force is applied to the pressure-sensing conductive rubber connector 13 placed between both printed pattern wirings 2 in order to fit the housing case 1a and the housing cover 1b together, and if the pressure-sensing conductive rubber connector 13 is disposed between the wiring circuit of the housing case 1a and the wiring circuit of the housing cover 1b, two printed pattern wirings 2 form a single printed pattern wiring 2 in a state where the housing case 1a and the housing cover 1b are fitted together.

In this state, when a detection signal is output to the printed pattern wiring 2, a detection output signal consisting of the same signal is detected, and the above-described security flag 7b is set to be normal. However, when someone disassembles the housing case 1a and the housing cover 1b, the compression force to the pressure-sensing conductive rubber connector 13 is removed to cause electric non-continuity to be brought about. Therefore, the printed pattern wiring 2 is disconnected halfway thereof, and the relationship between the circuit status flag 7a and the detection output signal becomes HIGH→LOW, wherein the abnormality determining section 4b determines an abnormality, and the security flag 7b is set to be abnormal.

Thus, with the information processing apparatus according to Embodiment 1, where a hole etc., is drilled to unlawfully take out information or where the printed pattern wiring 2 is short-circuited due to dust, etc., these are determined to be abnormal, wherein important programs and data stored in the memory 7 can be deleted, and the point can be notified to an administrator in real time via the interface 8, and a network, or via the interface 8, a modem and a telephone line. Therefore, a high security level can be obtained by which it becomes remarkably difficult to unlawfully take out information, and it is possible to detect an abnormality even if an erroneous operation occurs due to dust etc.

The present invention is applicable to an information processing apparatus having a security housing.

Although the invention has been illustrated and described for the particular preferred embodiments, it is apparent to a person skilled in the art that various changes and modifications can be made on the basis of the teachings of the invention. It is apparent that such changes and modifications are within the spirit, scope, and intention of the invention as defined by the appended claims.

The present application is based on Japan Patent Application No. 2007-263114 filed on Oct. 9, 2007, the contents of which are incorporated herein for reference.

What is claimed is:

1. An information processing apparatus, comprising:
a housing that accommodates electronic components for processing security information;
a power source that supplies power to the electronic components;
a detection circuit that is connected in parallel to the power source with respect to the electronic components and detects an abnormality when a physical opening action affects the housing;
a memory processing section that deletes the security information or makes ft impossible to read out the security information from a memory in the electronic components when the abnormality is detected; and
a notifying section that notifies the abnormality when the abnormality is detected,
wherein when the abnormality is detected, power is supplied from the power source to the memory.

2. The information processing apparatus according to claim 1, wherein the detection circuit includes a printed pattern wiring and a detection controlling section which detects an abnormality in the printed pattern wiring by outputting a predetermined detection signal to the printed pattern wiring and detecting a detection output signal from the printed pattern wiring.

3. The information processing apparatus according to claim 2, wherein the detection controlling section includes an abnormality determining section which determines that, when the detection signal is coincident with the detection output signal, the housing is normal, and that, when the detection signal is not coincident with the detection output signal, the housing is abnormal.

4. The information processing apparatus according to claim 3, wherein the printed pattern wiring includes a first conductor circuit and a second conductor circuit which are independent of each other;
wherein a first detection signal is output to the first conductor circuit and a second detection signal is output to the second conductor circuit, respectively, and a first combination of the respective detection output signals is detected; and
wherein the second detection signal is output to the first conductor circuit and the first detection signal is output to the second conductor circuit, respectively, and a second combination of the respective detection output signals is detected; and
wherein the abnormality determining section determines that the housing is normal when the first combination and the second combination are coincident with predetermined combinations, and determines that the housing is abnormal when the first combination and the second combination are not coincident with the predetermined combinations.

5. The information processing apparatus according to claim 4, wherein the abnormality determining section determines that the first conductor circuit and the second conductor circuit are short-circuited based on the first and second combinations of the respective detection output signals.

6. The information processing apparatus according to claim 2, wherein the housing includes a first case and a second case;
wherein the printed pattern wiring has a first wiring portion provided on the first case and a second wiring portion provided on the second case; and
wherein when the first case is engaged with the second case, the first wiring portion is electrically conducted to the second wiring portion so that the printed pattern wiring serves as a single wire.

7. The information processing apparatus according to claim 2, wherein the housing includes a first case and a second case;
wherein the printed pattern wiring has a pressure-sensing conductive connector, a first wiring portion provided on the first case, and a second wiring portion provided on the second case;
wherein when the first case is engaged with the second case, the pressure-sensing conductive connector is pressed, thereby the first wiring portion is electrically conducted to the second wiring portion through the pressure-sensing conductive connector so that the printed pattern wiring serves as a single wire.

8. The information processing apparatus according to claim 2, wherein the printed pattern circuit wiring is directly formed on an inside of the housing by thermal transfer processing.
